(19) United States
(12) Patent Application Publication
(10) Pub. No.: US 2012/0228208 A1
(43) Pub. Date: Sep. 13, 2012

(54) INTERCONNECTOR FOR FILTRATION APPARATUS WITH REDUCED PERMEATE PRESSURE LOSS

(75) Inventors: Yatin TAYALIA, Singapore (SG); Prasanna Rao DONTULA, Bangalore (IN); Upen J. BHARWADA, Scottsdale, AZ (US)

(73) Assignee: GENERAL ELECTRIC COMPANY, Schenectady, NY (US)

(21) Appl. No.: 13/046,355

(22) Filed: Mar. 11, 2011

(51) Int. Cl. B01D 63/00; B01D 61/14; B01D 63/12; B01D 61/08

(52) U.S. Cl. 210/321.83; 210/321.6

(57) ABSTRACT

An interconnector coupling permeate conduits in a filtration apparatus includes a diverging section. The diverging section defines a generally increasing cross sectional area for the permeate solution exiting the interconnector in a direction of flow from the permeate conduit of a first separation element to a permeate conduit of a second separation element. The diverging section provides a more gradual divergence of the permeate solution to reduce pressure losses.

### FIELD

This specification relates to filtration using semipermeable separation elements, for example, spiral wound membranes used in reverse osmosis, nanofiltration, ultrafiltration and microfiltration processes.

### BACKGROUND

The following background discussion is not an admission that anything discussed below is citable as prior art or common general knowledge.

U.S. Pat. No. 5,851,267 describes a separation module that uses a series of separation elements with interconnecting hardware that reduces the time necessary for assembly of interconnected elements and the machining or preparation of an extended part of the module inside diameter for acceptance of the elements. The elements use an interconnection between the modules that provides a sliding seal for first engaging adjacent modules and allowing alignment while a secondary seal is brought into contact and locked to provide a rigid axial attachment between the separation elements.

U.S. Pat. No. 6,632,356 describes a separation end cap adapted for connecting adjacent separation elements. The end cap can be located at the distal ends of a separation element and is adapted for connection with a permeate tube located within the separation element. In one embodiment the end cap includes an inner hub for receiving an O-ring to seal against an inner hub of an end cap on an adjacent separation element.

U.S. Pat. No. 7,387,731 describes a coupler for a spiral membrane filtration element having a spiral membrane enclosed within a rigid outerwrap includes a center support, a plurality of spokes extending outwardly from the center support, a circular rim coupled with the spokes, with the face of the rim being perpendicular to the axis of the overwrap. The rim includes a channel on its face for receiving a compressible seal, and a plurality of receptacles around its outer surface for joining two face-to-face adjacent couplers when a pair of aligned keepers is place in each receptacle.

### Introduction

The following discussion is intended to introduce the reader to the more detailed discussion to follow, and not to limit or define any claim.

Reverse osmosis and nanofiltration are filtration methods that can be used to create potable water from seawater. Simple reverse osmosis systems, such as single stage desalination systems, can use multiple separation elements placed in line in a common pressure vessel. Each of the separation elements can include a permeate conduit for collection of the filtered permeate solution. The permeate conduits can be connected in series using interconnectors. In such configurations, permeate solution can be forced through a series of contractions and expansions as it flows through the permeate conduits and the interconnectors, which can cause significant pressure losses. Pressure loss can be mitigated, for example, by enlarging the inner diameter of the permeate conduits, or by using interconnectors having an inner diameter that is larger than the permeate conduits. Another approach is to eliminate the use of interconnectors and provide another mechanism of sealing the permeate from the feed, for example, the interlocking end-cap described in U.S. Pat. No. 6,632,356.

Described herein is an apparatus in which an interconnector includes a diverging section of increasing cross sectional area exiting into the permeate conduit. The interconnector can further include a converging section of decreasing cross sectional area. With the arrangement of converging and diverging sections, the interconnector resembles a Venturi design. The diverging section can provide a more gradual divergence of the permeate solution exiting the interconnector, which reduces flow separation from the permeate conduit and thus can reduce pressure losses. Combined converging and diverging sections can result in even lower pressure losses. The reduced pressure loss in the permeate conduits can raise the net driving pressure for flow across the separation elements, as well as increasing the flow of permeate solution per element, thereby improving the energy efficiency of the filtration process. Higher permeate flows per element, at same solute rejections, can translate to more compact filtration plants with lower capital expenditure.

### DRAWINGS

FIG. 1 is a schematic view of an example of a filtration apparatus.

FIGS. 2A and 2B are sectional views of examples of interconnectors used in the filtration apparatus shown in FIG. 1.

FIG. 3 is a schematic view of an interconnector showing various possible geometries.

FIGS. 4A and 4B are graphs showing simulation results using different interconnectors.

FIGS. 5A, 5B, 5C, 5D, 6A, 6B and 6C are partial sectional views of further examples of interconnectors used in the filtration apparatus shown in FIG. 1.

For simplicity and clarity of illustration, where considered appropriate, reference numerals may be repeated among the drawings to indicate corresponding or analogous elements.

### DETAILED DESCRIPTION

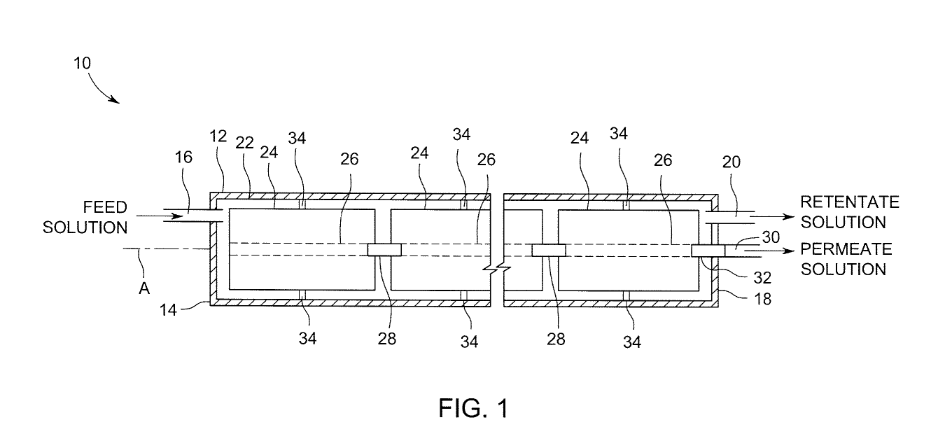

FIG. 1 shows an example of a filtration apparatus 10. The apparatus 10 includes a housing 12. A first end 14 of the housing 12 includes an inlet port 16 (which can be an end port as illustrated) for receiving a pressurized feed solution. A second end 18 of the housing 12 spaced apart from the first end 14 includes an outlet port 20 (which can be an end port as illustrated) for expelling a retentate solution. The housing 12 defines an elongate chamber or pressure vessel 22 between the first and second ends 14, 18.

The apparatus 10 includes a plurality of separation elements or modules 24 arranged in series within the chamber 22. For clarity of illustration, only a few modules are shown, although an apparatus of this type can in practice be sized to hold six to eight or more separation elements 24.

In the example illustrated, peripheral seals 34 extend around the outer side of each of the separation elements 24, and seal against the inner wall of the chamber 22 to ensure that the feed solution proceeds downstream from the first end 14 to the second end 18 within the chamber 22, in series sequentially through each of the separation elements 24.

Each of the separation elements 24 includes a permeate conduit 26 for collecting filtered permeate solution therein. In the example illustrated, the permeate conduits 26 are axially arranged along a central axis A of the chamber 22. The permeate conduits 26 are connected to each other via interconnectors 28, so that permeate solution can flow axially between the permeate conduits 26 of adjacent ones of the separation elements 24.

In the example illustrated, the permeate conduit 26 of the tail separation element 24 connects to a permeate outlet 30 via an end connector 32, which is shown extending out of an end wall at the second end 18 of the housing 12, adjacent to the outlet port 20. The apparatus 10 can further include an end connector and a permeate outlet (not shown) at the first end 14 of the housing 12, allowing permeate to flow from the permeate conduit 26 of the lead element 24 out of an end wall at the first end 14 the housing 12.

The separation elements 24 can comprise semi-permeable membranes that allow some components in a liquid solution to pass through while stopping other components. For example, each of the separation elements 24 can comprise spiral-wound membranes. Such separation elements include sheet membranes wrapped around its respective permeate conduit 26 to form an envelope that is spiral-wound with one or more feed spacers into a cylinder-shaped cartridge, with the permeable spacer in fluid communication with the respective permeate conduit 26. Each of the separation elements 24 can include an end cap or plate (not shown) to provide shape and structural rigidity, which can aid in assuring a generally open fluid path for the feed solution to optimally reach exposed surfaces of the outside membranes of the separation elements 24, and which can also help resist telescoping or deformation under high pressure flows within the chamber 22.

When a plurality of separation elements 24 are used in series, as in the apparatus 10 shown in FIG. 1, the permeate conduits 26 of adjacent ones of the separation elements 24 can be sealed to each other to prevent mixing of feed and/or retentate solution with the permeate solution. This can be achieved by means of the interconnectors 28, which can be configured to fit between the adjacent permeate conduits 26 and segregate the feed and retentate solutions from the permeate solution.

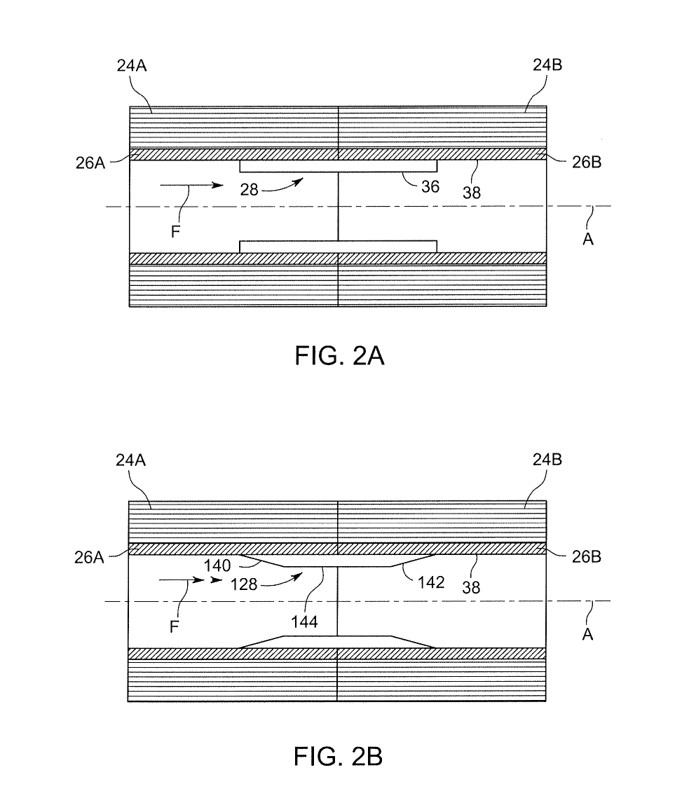

Referring to FIG. 2A, a generally cylindrical interconnector 28 is shown received within ends of the respective permeate conduits 26a, 26b of adjacent separation elements 24a, 24b. An arrangement of radially compressed single or double O-rings (not shown) can be used to ensure good sealing between the permeate conduits 26a, 26b and the interconnector 28.

Permeate solution flows in direction of flow f from the permeate conduit 26a, through the narrowed cross sectional area defined by an inner surface 36 of the interconnector 28, and exits into the permeate conduit 26b. The inner surface 36 can have a generally constant inner diameter across its length (but it is possible for the inner surface 36 to include a relatively small draft angle of, for example, less than 1 degree, to aid in the manufacturing of the interconnector 28 by injection molding). The permeate conduit 26b has an inner wall 38 that can have a significantly larger inner diameter than that of the inner surface 36 of the interconnector 28.

In such configurations, the permeate solution is forced through a series of contractions and expansions as it flows through the permeate conduits 26 from the first end 14 to the second end 18 of the apparatus 10 (FIG. 1). The contractions and expansions can result in significant pressure losses. For example, about 0.9 bar in pressure can be lost due to the flow of permeate solution through the permeate conduits and interconnectors between six high-flux brackish water reverse osmosis elements arranged axially in a single pressure vessel.

An analysis of the flow in these contraction-expansion geometries reveals that, in some examples, as much as half of the pressure can be lost in the section of relatively abrupt expansion in cross-sectional area where the permeate solution exits from the interconnector 28 and flows into the permeate conduit 26b. The inventors have determined that pressure losses at the contraction in cross-sectional area where the permeate solution enters the interconnector 28 from the permeate conduit 26a tend to be much lower than in the exit section. The relatively sharp increase in diameter along the direction of flow f between the inner surface 36 and the inner wall 38 can cause the permeate solution to be separated from the inner wall 38 of the permeate conduits 26, forming regions where the permeate solution recirculates in vortices. Larger and more intense vortices can irreversibly dissipate greater energy and pressure. The inventors propose to reduce these pressure losses by providing a more gradual divergence of the permeate solution at the exit of the interconnector, reducing flow separation and its associated pressure losses.

Referring to FIG. 2B, an interconnector 128 is shown received within ends of the permeate conduits 26a, 26b. As illustrated, the interconnector 128 includes a converging section 140 having a gradually decreasing inner diameter, defining a decreasing cross sectional area for the permeate solution entering the interconnector 128 in the direction of flow f. The interconnector further includes a diverging section 142 having a gradually increasing inner diameter, defining an increasing cross sectional area for the permeate solution exiting the interconnector 128. The interconnector 128 further includes a throat section 144 coupling the converging and diverging sections 140, 142. The throat section 144 can define a generally constant cross sectional area. The diverging section 142 provides a more gradual divergence of the permeate solution exiting the interconnector 128, reducing flow separation and its associated pressure losses. With the arrangement of the converging and diverging sections 140, 142, the interconnector 128 resembles a Venturi design.

However, it should be appreciated that the teachings herein are not necessarily restricted to gradually diverging/converging geometries and other inner surface profiles of the interconnectors can be utilized to reduce flow separation and its associated pressure losses.

The converging and diverging geometries can be optimized to reduce pressure losses over range of flows for a given filtration apparatus. Fluid dynamics theory suggests that converging and diverging angles in range 1 to 10 degrees can be suitable to significantly reduce pressure losses in some conventional filtration apparatuses.

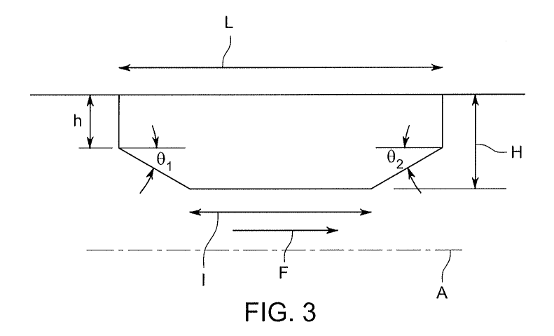

By way of example, Table 1, with reference to FIG. 3, provides geometries for six interconnectors, which are labeled as Cases A to F. The parameters are as follows:
H, the total protrusion of the interconnector inside the permeate conduit, is 0.15 inches;
h, the step height, varying from 0 to 81% of H;
L, the interconnector length, is 5.9 inches;
I, the throat section length, varying from 1.87 to 5.9 inches; and
θ1 (converging angle) and θ2 (diverging angle) vary from 0 to 10 degrees.

TABLE 1
Interconnector geometries.

| | | | | | Throat |
|---|---|---|---|---|---|
| | | | | | section |
| | Protrustion h | Protrusion h | | | length |
| Case | (inches) | (% of H) | θ₁ | θ₂ | (inches) |
| A | 0.15 | 100 | 0 | 0 | 5.9 |
| B | 0 | 0 | 9 | 9 | 3.8 |
| C | 0 | 0 | 10 | 10 | 4.2 |
| D | 0.405 | 27 | 7 | 2 | 1.87 |
| E | 0.405 | 27 | 7 | 4 | 3.44 |
| F | 0.1215 | 81 | 4 | 1 | 3.86 |

Case A resembles the interconnector 28 shown in FIG. 2A, without converging or diverging sections. Case B resembles the interconnector shown in FIG. 2B with converging and diverging sections of equal length and a 3.8″ long throat section (in practice, the throat length versus the length of the interconnector can vary from about 30 to about 87%). Inner diameters of the throat sections for Cases A and B are identical.

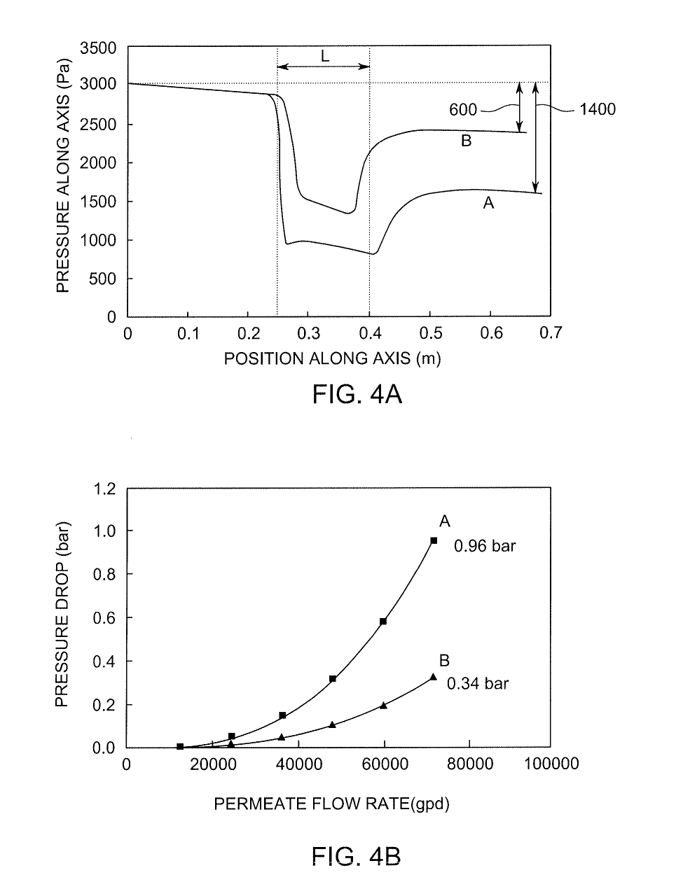

For Cases A and B, a computational fluid dynamics simulation was conducted to simulate the performance of the geometries in use. FIG. 4A illustrates static pressure, along axis A, of permeate flowing through length L of a single interconnector as per Cases A and B. 12000 gpd of permeate solution flow was assumed for a permeate conduit having an inner diameter of 1 inch; frictional pressure loss within the permeate conduits was fixed at 416.7 Pa/m. After the permeate solution flows through the interconnector, Case A exhibited a pressure loss of about 1400 Pa, whereas Case B exhibited a pressure loss of about 600 Pa. FIG. 4B illustrates pressure loss across a pressure vessel housing six separation elements arranged in series. Each permeate conduit was fixed at 20 inches in length and with an inner diameter of 1 inch. 12000 gpd of permeate solution production per separation element was assumed. Elements with interconnectors having the geometry of Case A exhibited a pressure drop of about 0.96 bar, whereas elements with interconnectors having the geometry of Case B exhibited a pressure drop of about 0.34 bar.

Since pressure of the feed solution is limited by material and energy considerations, a lower pressure drop of the permeate solution across the pressure vessel raises the available pressure drop to drive the flow of permeate solution through the separation elements. The flow through the separation elements can vary directly with the applied pressure across the separation elements, and hence any reduction in pressure losses on the permeate side can enhance throughput of permeate solution.

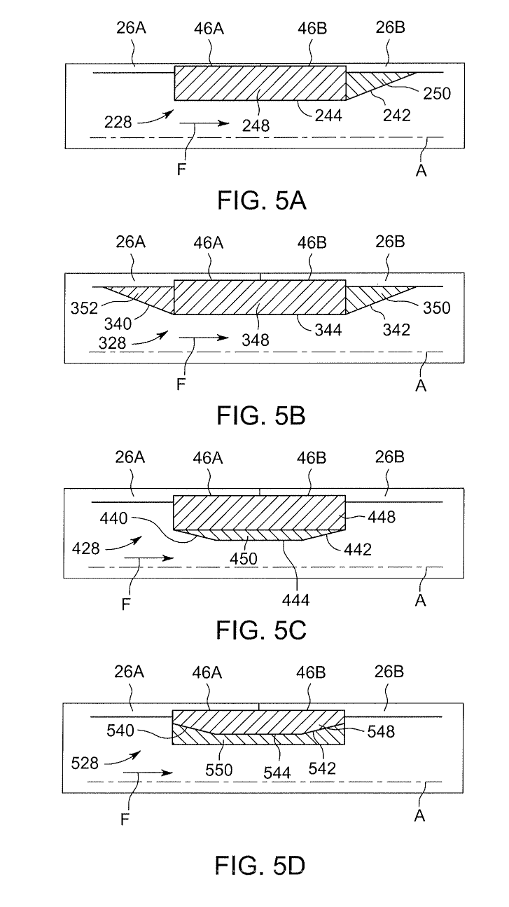

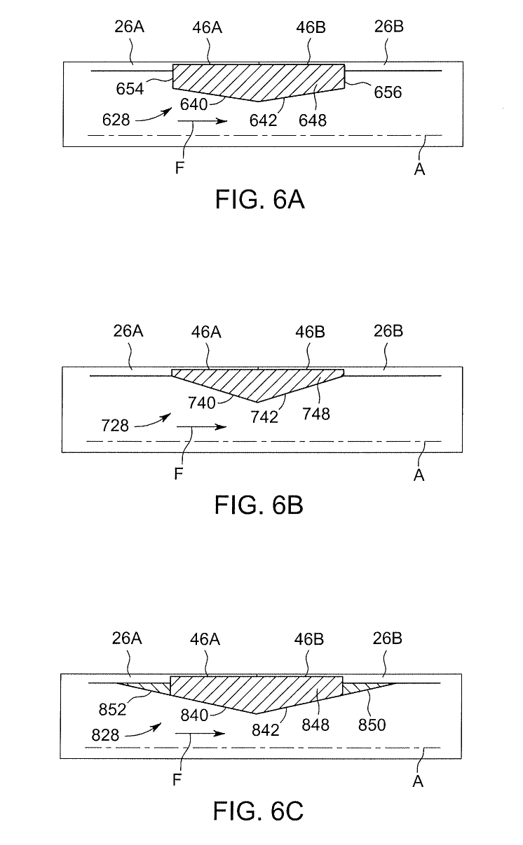

FIGS. 5A, 5B, 5C, 5D, 6A, 6B and 6C illustrate various examples of interconnectors. In each case, ends of the permeate conduits 26a, 26b are illustrated to include a recess or counterbore 46a, 46b, respectively, for receiving and supporting the interconnector.

Referring to FIG. 5A, an interconnector 228 includes a first portion 248 defining a throat section 244, and a second portion 250 defining a diverging section 242 having an increasing cross sectional area relative a direction of flow f. The second portion 250 extends beyond the longitudinal extent of the recess 46b, permitting a larger throat section 244. The first and second portions 248, 250 can be integral or separate components. Further, the second portion 250 can be connected to the first portion 248 to retrofit an existing interconnector (consisting of the first portion 248) to create the diverging section 242.

Referring to FIG. 5B, an interconnector 328 is similar to the interconnector 228, with the difference being that the interconnector 328 further includes a third portion 352 defining a converging section 340 having a decreasing cross sectional area relative to the direction of flow f. The second and third portions 350, 352 can be connected to the first portion 348 to retrofit an existing interconnector (consisting of the first portion 348) to create the converging and diverging sections 340, 342.

Referring to FIG. 5C, an interconnector 428 includes a first portion 448 received in the recesses 46a, 46b. A second portion 450 defines a converging section 440, a diverging section 442 and a throat section 444. Again, the second portion 450 can be connected to the first portion 448 to retrofit an existing interconnector (consisting of the first portion 448); however, addition of the second portion 450 causes the overall cross sectional area through the interconnector 428 to be reduced.

Referring to FIG. 5D, an interconnector 528 includes a first portion 548 received in the recesses 46a, 46b. A second portion 550 can be removed from the interconnector 528 as a retrofit, exposing a converging section 540, a diverging section 542 and a throat section 544 of the first portion 548.

Referring to FIG. 6A, an interconnector 628 includes a first portion 648 received in the recesses 46a, 46b. The first portion 648 defines converging and diverging sections 640, 642 in which the cross section area respectively decreases and increases relative to the direction of flow f, without a throat section. The converging and diverging sections 640, 642 terminate at respective end sections 654, 656.

Referring to FIG. 6B, an interconnector 728 is similar to the interconnector 628, with the difference being that converging and diverging sections 740, 742 of the interconnector 728 terminate generally flush with the permeate conduits 26a, 26b, respectively, without end sections.

Referring to FIG. 6C, an interconnector 828 is similar to the interconnector 628, with a difference being that the interconnector 828 further includes second and third portions 850, 852. The diverging section 842 is defined by first and second portions 848, 850, and a converging section 840 is defined by first and third portions 848, 852. The diverging section 842 provides an increasing cross sectional area to carry permeate solution in the direction of flow f, and the converging section 840 provides a decreasing cross sectional area to carry permeate solution in the direction of flow f.

The interconnectors described herein can be manufactured by extrusion or injection molding, or by machining, or by a combination thereof. Materials such as engineering plastics and composite materials can be used to reduce dimensions of the interconnectors generally without sacrificing strength and the amount of membrane area that can be accommodated in a spiral-wound separation element.

Referring back to FIG. 1, the end connector 32 extending out of the second end 18, and an end connector (not shown) extending out of the first end 16 can be configured in a similar manner to that of the interconnectors described herein. Other components carrying fluid flow within a filtration apparatus can be configured in a similar manner to that of the interconnectors described herein.

What is claimed is:

1. A filtration apparatus, comprising:
at least first and second separation elements arranged in series, each of the separation elements including a permeate conduit; and
an interconnector coupling the permeate conduits, the interconnector including a diverging section defining a generally increasing cross sectional area for permeate solution exiting the interconnector in a direction of flow from the permeate conduit of the first separation element to the permeate conduit of the second separation element.

2. The apparatus of claim 1, wherein an inner diameter of the diverging section gradually increases relative to the direction of flow.

3. The apparatus of claim 2, wherein a diverging angle defined by the inner diameter of the diverging section is between 1 and 10 degrees relative to a longitudinal axis of the interconnector.

4. The apparatus of claim 3, wherein the interconnector further comprises a converging section defining a generally decreasing cross sectional area for the permeate solution entering the interconnector in the direction of flow.

5. The apparatus of claim 4, wherein an inner diameter of the converging section gradually decreases relative to the direction of flow.

6. The apparatus of claim 5, wherein a converging angle defined by the inner diameter of the converging section is between 1 and 10 degrees relative to a longitudinal axis of the interconnector.

7. The apparatus of claim 4, wherein the converging section is coupled directly to the diverging section.

8. The apparatus of claim 4, wherein the interconnector further comprises a throat section coupling the converging and diverging sections, the throat section defining a generally constant cross sectional area in the direction of flow.

9. The apparatus of claim 8, wherein a length of the throat section is about 30 to about 87% of a length of the interconnector.

10. The apparatus of claim 1, wherein the interconnector comprises two or more portions.

11. The apparatus of claim 1, wherein ends of the permeate conduits comprise recesses configured to receive the interconnector, and the interconnector extends beyond the longitudinal extent of at least one of the recesses.

12. The apparatus of claim 1, wherein each of the separation elements comprises spiral-wound reverse osmosis, nanofiltration, ultrafiltration or microfiltration membranes.

13. A filtration apparatus, comprising:
at least first and second separation elements arranged in series, each of the separation elements including a permeate conduit; and
an interconnector coupling the permeate conduits, the interconnector including a converging section for permeate solution entering the interconnector in a direction of flow from the permeate conduit of the first separation element to the permeate conduit of the second separation element, and a diverging section exiting the interconnector in the direction of flow to the permeate conduit of the second separation element.

14. A filtration apparatus, comprising:
a housing including an inlet port for receiving a feed solution and an outlet port for expelling a retentate solution, the housing defining a chamber between the inlet and outlet ports;
at least one separation element arranged in the housing, the separation element including a permeate conduit;
a permeate outlet arranged out of the housing; and
an end connector coupling the permeate conduit of the separation element to the permeate outlet, the end connector including a converging section for permeate solution entering the end connector in a direction of flow from the permeate conduit to the permeate outlet, and a diverging section exiting the end connector in the direction of flow to the permeate outlet.
